(19) United States
(12) Patent Application Publication
(10) Pub. No.: US 2003/0103293 A1
(43) Pub. Date: Jun. 5, 2003

(54) Head slider and disk device

(76) Inventors: Naoki Nakano, Ome-shi (JP); Jun Ito, Ome-shi (JP)

Correspondence Address: PILLSBURY WINTHROP, LLP, P.O. BOX 10500, MCLEAN, VA, 22102, US

(21) Appl. No.: 10/234,700

(22) Filed: Sep. 5, 2002

(30) Foreign Application Priority Data
Nov. 30, 2001 (JP) 2001-367821

(51) Int. Cl. G11B 5/60

(52) U.S. Cl. 360/236.3

(57) ABSTRACT

An HDD has a suspension arm that swings with a head slider with a magnetic head pressed against the surface of a rotating magnetic disk. When the suspension arm swings, the head slider is radially moved over the magnetic disk, kept in contact with the disk surface. The pressure of the air flowing between the head slider and disk surface is increased to thereby enhance the resistance of the head slider against an external impact. Further, to reduce the contact force of the head slider upon the disk surface, a negative pressure Fn is generated between the head slider and disk surface.

### CROSS-REFERENCE TO RELATED APPLICATIONS

This application is based upon and claims the benefit of priority from the prior Japanese Patent Application No. 2001-367821, filed Nov. 30, 2001, the entire contents of which are incorporated herein by reference.

### BACKGROUND OF THE INVENTION

1. Field of the Invention

The present invention relates to a contact-type head slider that moves in the radial direction of a rotary disk medium (hereinafter referred to simply as a “disk”) in a state in which the slider is in contact with the surface of the disk.

2. Description of the Related Art

In general, a disk device comprises a spindle motor that supports and rotates a disk, a suspension arm having a head slider provided at its free end, a head mounted on the head slider, and a voice coil motor (hereinafter referred to as a “VCM”) for radially swinging the head, mounted on the suspension arm, over the surface of the disk, etc.

The suspension arm is attached so that it presses the head slider against the disk with a predetermined force. During operation, the disk is rotated with the head slider kept in contact with the surface of the disk, whereby the head slider is radially slid over the disk. As a result, the head opposes a desired track of the disk, and records information on the track or reproduces information therefrom.

At this time, the head slider is pressed in a direction away from the disk by the pressure of the air formed from the rotation of the disk. As a result, the head slider is inclined about the position in which the pressing force of the suspension arm is exerted, thereby bringing a part of the head slider into contact with the disk.

In light of wear of the head slider or damage of the disk, the contact force of the head slider upon the disk should be minimized. To this end, in conventional disk devices, the place at which the suspension arm presses the head slider is made as close as possible to the place at which the air pressure is exerted.

However, where the pressing position of the suspension arm is close to the air-pressure acting position, if an impact is exerted upon the head slider from the outside, the head slider is easily inclined, thereby undesirably changing the contact force of the head slider upon the disk.

If the contact force is unstable, the head slider may become away from the disk to thereby reduce the level of a signal during recording or reproduction, or the head slider may touch the disk with a too strong force to unevenly wear the contact portion or damage the disk.

### BRIEF SUMMARY OF THE INVENTION

The present invention has been developed in light of the above, and aims to provide a head slider that has a high stability against vibration and can be brought into reliable contact with a disk with an extremely small contact force, and to also provide a disk device incorporating the head slider.

To satisfy the aim, according to an aspect of the invention, there is provided a head slider mounted with a head which records information on a rotating disk medium, and/or reproduces information therefrom, the head slider substantially radially moving over the rotating disk medium in a state in which a part of the head slider is in contact with a surface of the rotating disk medium, comprising: a contact portion to be brought into contact with the surface of the disk medium, the portion of the surface of the head slider being located downstream of a pressing position with respect to rotation of the disk medium, a pressing force being exerted upon the head slider at the pressing position to press the head slider against the surface of the disk medium; a positive-pressure-generating portion located upstream of the pressing position with respect to the rotation of the disk medium, a positive pressure resulting, at the positive-pressure-generating portion, from airflow which occurs while the disk medium is rotating, thereby pressing the head slider away from the disk medium; and a negative-pressure-generating portion located upstream of the positive-pressure-generating portion with respect to the rotation of the disk medium, a negative pressure resulting from the airflow at the negative-pressure-generating portion, thereby pressing the head slider toward the disk medium.

The head slider of the invention has a contact portion located downstream of the pressing position, in which a pressing force is exerted upon the head slider, with respect to the direction of rotation of the disk medium, and a positive-pressure-generating portion located upstream of the pressing position with respect to the direction of the rotation. Accordingly, the head slider is pressed against the surface of the disk medium with a predetermined pressing force. Further, the head slider has a negative-pressure-generating portion located upstream of the positive-pressure-generating portion with respect to the direction of the rotation. This enhances the stability of the head slider against vibration, and enables the contact force of the contact portion upon the disk medium to be made constant and minimized. As a result, level reduction in a signal due to changes in the contact force can be suppressed, and wear of the contact portion or damage of the disk medium can also be suppressed.

According to another aspect of the invention, there is provided a disk device comprising: a disk medium; a spindle motor which supports and rotates the disk medium; a head slider mounted with a head which records information on the disk medium and/or reproduces information therefrom while the disk medium is rotating; a suspension arm having a free end provided with the head slider; and a voice coil motor which swings the suspension arm to substantially radially move the head slider over the disk medium while the disk medium is rotating, in a state in which a part of the head slider is in contact with a surface of the rotating disk medium, thereby positioning the head above a desired track of the disk medium, wherein the head slider includes: a contact portion to be brought into contact with a portion of the surface of the disk medium, the portion of the surface of the head slider being located downstream of a pressing position with respect to rotation of the disk medium, a pressing force being exerted upon the head slider at the pressing position to press the head slider against the surface of the disk medium; a positive-pressure-generating portion located upstream of the pressing position with respect to the rotation of the disk medium, a positive pressure resulting, at the positive-pressure-generating portion, from airflow which occurs while the disk medium is rotating, thereby pressing the head slider away from the disk medium; and a negative-pressure-generating portion located upstream of the positive-pressure-generating portion with respect to the rotation of the disk medium, a negative pressure resulting from the airflow at the negative-pressure-generating portion, thereby pressing the head slider toward the disk medium.

Since the head slider and disk device of the invention have the structures and advantages described as above, the stability of the head slider against vibration is enhanced, and the contact force of the contact portion upon the disk medium can be set to an extremely low, constant value. Accordingly, the vibration of the head slider that occurs when an external impact is exerted upon the disk device can be suppressed, thereby suppressing variations in the contact force upon the disk. Further, wear of the head slider and/or damage of the disk, which may occur when the head slider is brought into contact with the disk, can be suppressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic perspective view illustrating the internal structure of a hard disk drive (HDD) according to the invention;

FIG. 2 is a perspective view illustrating an essential part of a head slider, according to a first embodiment of the invention, attached to the free end of a suspension arm incorporated in the HDD of FIG. 1;

FIG. 3 is a plan view illustrating the head slider of FIG. 2 when viewed from the magnetic disk side;

FIG. 4 is a side view illustrating the head slider of FIG. 2 when viewed in the radial direction of the magnetic disk;

FIG. 5 is a side view illustrating the head slider of FIG. 2 when viewed from the air-inlet side;

FIG. 6 is a view useful in explaining the height of a pad provided on the counter surface of the head slider of FIG. 2 opposing the magnetic disk;

FIG. 7 is a view useful in explaining the forces acting upon the head slider of FIG. 2;

FIG. 8 is a view useful in explaining the physical properties of a conventional head slider that does not generate a negative pressure;

FIG. 9 is a view useful in explaining the physical properties of the head slider of the present invention that generates a negative pressure;

FIG. 10 is a plan view illustrating a head slider according to a second embodiment of the invention when viewed from the magnetic disk side;

FIG. 11 is a plan view illustrating a head slider according to a third embodiment of the invention when viewed from the magnetic disk side;

FIG. 12 is a plan view illustrating a head slider according to a fourth embodiment of the invention when viewed from the magnetic disk side;

FIG. 13 is a plan view illustrating a head slider according to a fifth embodiment of the invention when viewed from the magnetic disk side;

FIG. 14 is a plan view illustrating a head slider according to a sixth embodiment of the invention when viewed from the magnetic disk side; and

FIG. 15 is a plan view illustrating a head slider according to a seventh embodiment of the invention when viewed from the magnetic disk side.

### DETAILED DESCRIPTION OF THE INVENTION

The embodiments of the invention will be described in detail with reference to the accompanying drawings.

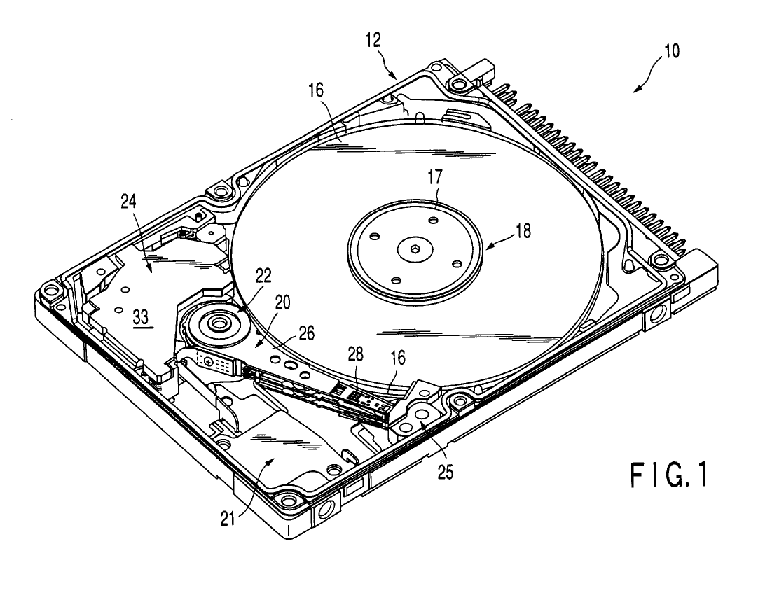

FIG. 1 is a schematic perspective view illustrating the structure of a hard disk drive 10 (hereinafter referred to as an “HDD 10”) as a disk device according to the invention. As shown, the HDD 10 comprises a rectangular-box-shaped case 12 having an upper opening, and a top cover (not shown) that closes the upper opening of the case when it is secured to the case by a plurality of screws. For showing the internal structure of the HDD 10, FIG. 1 shows the state in which the top cover is detached.

The case 12 houses a plurality of (e.g. two) magnetic disks 16 as disk mediums; a spindle motor 18 that supports and rotates the magnetic disks 16; four suspension arms 20 each having a magnetic head (not shown) at its free end, the magnetic heads being provided for recording information on the respective surfaces of the magnetic disks 16 and reproducing information therefrom; a bearing assembly 22 which supports the suspension arms 20 so that they can pivot over the surfaces of the magnetic disks 16; a voice coil motor (hereinafter referred to as a “VCM”) 24 for pivoting and positioning the suspension arms 20; a ramp load mechanism 25 for holding the magnetic heads away from the magnetic disks 16 when they are moved beyond the outer periphery of the disks 16; and a board unit 21.

Each suspension arm 20 comprises an arm 26 having its proximal end attached to the bearing assembly 22, and a head suspension assembly (HSA) 28 attached to the free end of the arm 26. The HSA 28 supports and suspends a head slider (described later) mounted with a magnetic head (not shown). The suspension arms 20 are attached to the bearing assembly 22 under tension, thus the head sliders press against the disks 16.

A printed circuit board (not shown) for controlling the operations of the spindle motor 18, VCM 24 and magnetic heads via the board unit 21 is screwed to the outer surface of the bottom of the case 12.

The magnetic disks 16 have a diameter of 65 mm (2.5 inches) and magnetic recording layers on upper and lower surfaces. The magnetic disks 16 are coaxially fitted on the hub (not shown) of the spindle motor 18 and supported by a cranp spring 17. The two magnetic disks 16 are rotated at a predetermined speed by the spindle motor 18.

The four suspension arms 20 are swung around the bearing assembly 22 by the VCM 24, thus the magnetic heads radially move over the magnetic disks 16, to respective desired tracks on the disks, for data reading/writing.

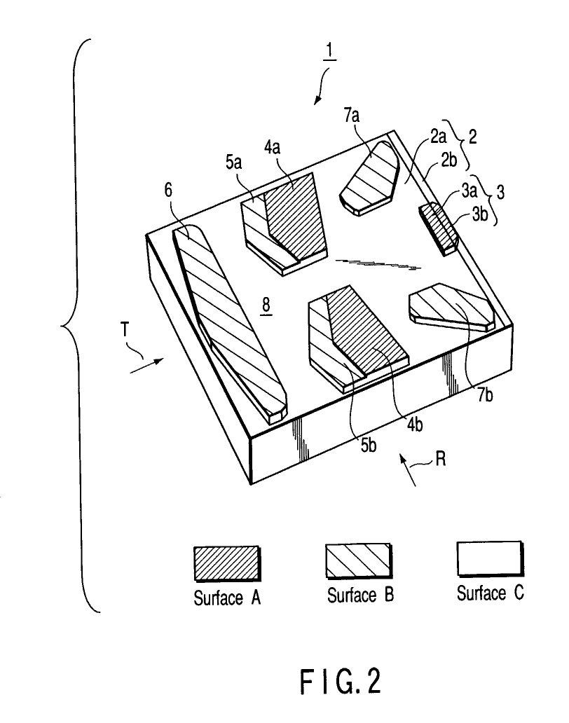

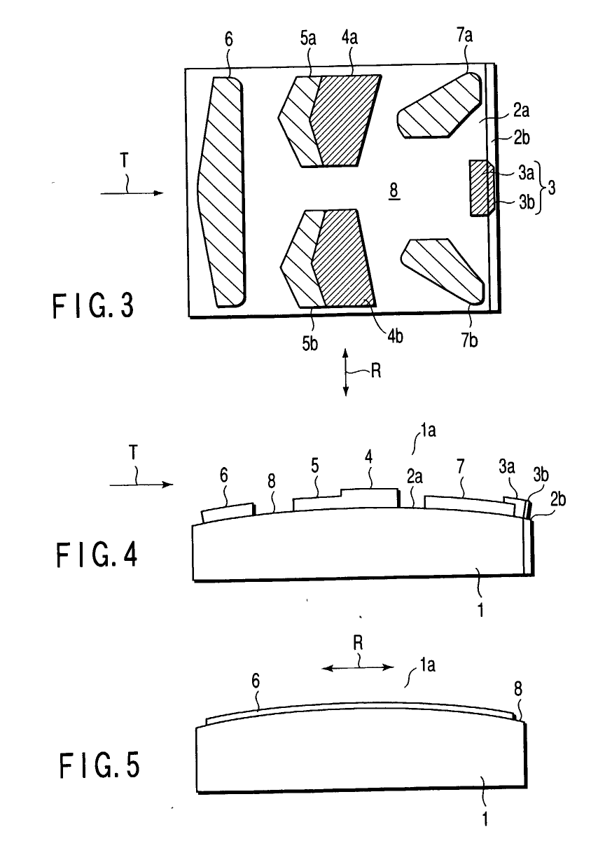

FIG. 2 is a perspective view illustrating an essential part of a head slider 1, according to a first embodiment of the invention. FIG. 3 is a plan view illustrating the head slider 1 of FIG. 2 as viewed from the magnetic disk 16 side. Further, FIG. 4 is a side view illustrating the head slider 1 as viewed in the direction indicated by arrow R in FIG. 2 (i.e., in the radial direction of the magnetic disk). Also, FIG. 5 is a side view illustrating the head slider 1 as viewed in the direction indicated by arrow T in FIG. 2 (i.e., from the air-inlet side, described later).

Each head slider 1 has a main body 2 of a substantially rectangular block shape, and the main body 2 has a counter surface 1a opposing the surface 16a of a corresponding magnetic disk 16. Each head slider 1 is basically positioned so that the longitudinal direction of the main body 2 is parallel to the direction indicated by arrow T, the width-direction of the main body 2 is parallel to the direction indicated by arrow R, and the counter surface 1a opposes the surface 16a of the corresponding magnetic disk 16 in substantially parallel thereto. However, since the corresponding magnetic disk 16 rotates and a corresponding suspension arm 20 swings, the angle of each head slider 1 with respect to each direction T or R slightly varies depending upon the position of each head slider 1 on the disk. For example, the angle of each head slider 1 with respect to the direction of rotation of a corresponding magnetic disk 16, i.e., the direction T, shifts by about 15 degrees at maximum to the right and to the left of the direction T, i.e., the angle range is about 30 degrees.

Further, as shown in FIGS. 4 and 5, the counter surface 1a has a convex shape, the central portion being highest, although this is irrelevant to the gist of the present invention. For the sake of argument, it is supposed in the description below that the counter surface 1a and the surfaces of all pads, described later, are substantially flat.

As shown, for example, in FIG. 2, the main body 2 of each head slider 1 comprises an upstream portion 2a and downstream portion 2b in the longitudinal direction, i.e., in the direction T. The upstream portion 2a, which occupies a greater part of the main body 2, is formed of AlTic (Al₂O₃—TiC), while the downstream portion 2b is formed of alumina. The direction T indicates, as well as the direction of rotation of each magnetic disk 16, the airflow over the disk surface 16a during rotation.

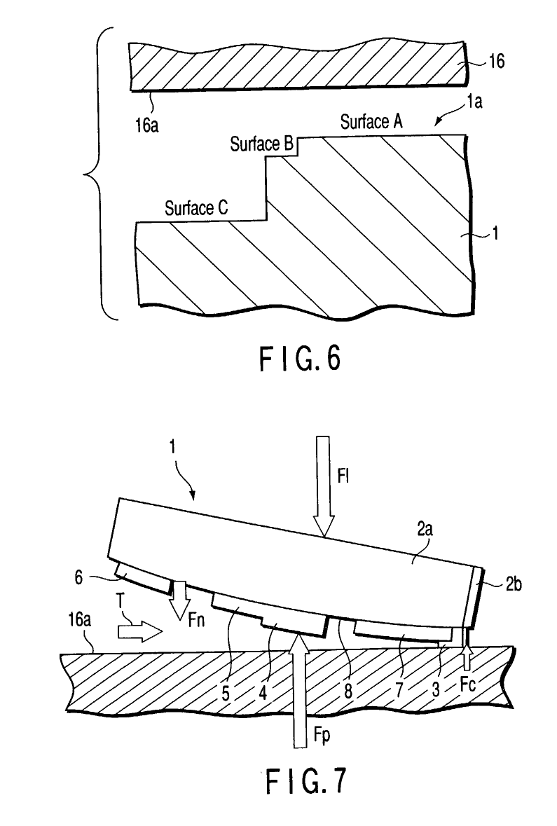

As shown, for example, in FIG. 3, the counter surface 1a of the head slider 1 is provided with a plurality of pads 3-7 in the form of islands of different shapes and heights. When the disk 16 rotates, the pads interrupt the airflow T between the disk surface 16a and the counter surface 1a, thereby changing the operational characteristics of the head slider 1. In the embodiment, the height of the counter surface 1a is varied in three stages as shown in FIG. 6, using the pads. Each pad has a surface A closest to the surface 16a of each disk 16 (i.e., the highest surface), or a surface B which is lower than the surface A by 0.1 μm-0.15 μm. The counter surface 1a with no pad has a surface C lower than the surface A by 1 μm-2 μm.

A pad 3 (contact portion), which has a surface A (contact surface) and is used to bring each head slider 1 into partial contact with the surface 16a of a corresponding magnetic disk 16, is provided on a substantially central portion of the counter surface 1a which includes a junction between the upstream and downstream portions 2a and 2b. The pad 3 has a portion 3a projecting from the upstream portion 2a, and a portion 3b projecting from the downstream portion 2b and formed integral with the portion 3a.

A pair of pads 4a and 4b (positive pressure generating portions) are provided on central portions of the counter surface 1a, located upstream of the pad 3 with respect to the direction T and separate from each other in the direction R. The two pads 4a and 4b are formed symmetrical with respect to the longitudinal direction of the head slider 1. The two pads 4a and 4b may be collectively referred to as a “pad 4”. Like the pad 3, the pads 4a and 4b each have a high surface A (positive pressure surface), i.e., closest to the disk surface 16a. The upstream end, i.e., air-inlet-side end, of each positive pressure surface A is V-shaped. The V-shaped air-inlet-side end provides an edge substantially perpendicular to the airflow even when each head slider 1 is inclined as aforementioned.

Further, a pair of pads 5a and 5b (which may be collectively referred to as a “pad 5”) each having a surface B lower than the positive pressure surface A of the pad 4 are provided adjacent to and upstream of the pads 4a and 4b. The pads 5a and 5b are formed integral with the pads 4a and 4b, respectively. For the same reason as the above, the upstream ends of the pads 5a and 5b are also V-shaped. The pads 5a and 5b serve to guide the airflow T to the positive pressure surfaces A.

A slim pad 6 (projection) extending in the direction R is provided upstream of the pad 5, i.e., near the air-inlet-side end of each head slider 1. The pad 6 has the surface B and a V-shaped upstream end for the same reason as the above. The pad 6 serves to generate a negative pressure, due to the airflow T, between the surface C (negative pressure generating portion) located downstream of the pad 6 and the disk surface 16a.

A pair of pads 7a and 7b (which may be collectively referred to as a “pad 7”) each having a surface B are provided upstream of the pad 3 and downstream of the pad 4, separate from each other in the direction R. The two pads 7a and 7b are formed symmetrical with respect to the longitudinal direction of each head slider 1, and function as damping portions for damping the oscillation of the head slider 1, thus stabilizing it, using a squeeze effect.

Referring now to FIG. 7, the forces acting upon the head slider 1 will be described.

Airflow T is caused by the rotation of a magnetic disk 16 between its surface 16a and the counter surface 1a of a corresponding head slider 1. The air in the airflow T is guided into the narrow space between the magnetic disk 16 and head slider 1, thereby forming, in the space, a layer of air with a predetermined pressure (positive pressure). The positive pressure Fp of the air layer mainly acts upon the positive pressure surface A of the pad 4 of each head slider 1. As a result, each head slider 1 is pressed in a direction away from the surface 16a of a corresponding magnetic disk 16.

On the other hand, the pressing force Fl of the suspension arm 20 is exerted upon the head slider 1. In the embodiment, the position, height and shape, etc. of the pad 4 are designed so that a positive pressure Fp, which acts in the direction opposite to that of the pressing force Fl, will act upon the head slider 1 at a position slightly upstream of the pressing position of the pressing force Fl. Accordingly, each head slider 1 is rotated and inclined in the direction in which its downstream end approaches a corresponding magnetic disk 16 as shown in FIG. 7.

As a result, the contact surface A of the pad 3 of the head slider 1 is brought into contact with the disk surface 16a. In this state, a contact force Fc is exerted by the disk 16 upon the contact surface A of the head slider 1. In the embodiment, since the pressing position of the aforementioned pressing force Fl is made close to the acting position of the positive pressure Fp, the contact force Fc acting upon the contact surface A of the pad 3 is extremely small.

Furthermore, a negative pressure Fn occurs, because of the airflow T, between the surface C downstream of the pad 6 and the disk surface 16a. The negative pressure Fn occurs because the pressure of the airflow T increased when it passes below the pad 6 is rapidly reduced. The negative pressure Fn presses the head slider 1 toward the surface 16a of the disk 16.

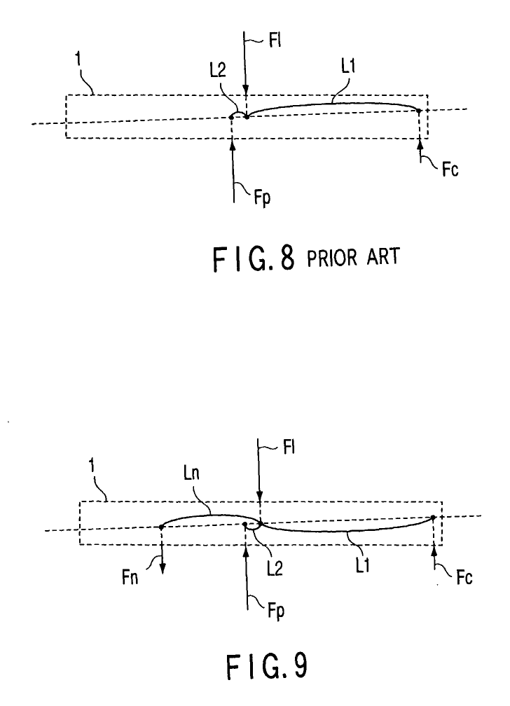

Referring then to FIGS. 8 and 9, the effect of the above-described negative pressure Fn will be described. FIG. 8 is a view useful in explaining a conventional head slider that does not generate the negative pressure Fn. FIG. 9 is a view useful in explaining the head slider of the present invention that generates the negative pressure Fn. In the figures, L1 represents the distance between the pressing position of the pressing force Fl and the acting position of the contact force Fc, L2 the distance between the pressing position of the pressing force Fl and the acting position of the positive pressure Fp, and Ln the distance between the pressing position of the pressing force Fl and the acting position of the negative pressure Fn.

In the case shown in FIG. 8 where no negative pressure occurs, i.e., where no pad 6 is provided, the contact force Fc acting upon the contact surface A of the pad 3 is given by

Fc=Fl×L2/(L1+L2)

On the other hand, in the case shown in FIG. 9 where the pad 6 is provided to generate the negative pressure Fn, the contact force Fc acting upon the contact surface A of the pad 3 is given by

Fc={Fl×L2−Fn(Ln−L2)}/(L1+L2)

In other words, the contact force Fc of the head slider 1 in the embodiment is smaller than that of the conventional head slider by Fn(Ln−L2)/(L1+L2).

On the other hand, in the embodiment, the force pressing the head slider 1 toward the magnetic disk 16 is larger by the negative pressure Fn than in the conventional head slider. Therefore, the positive pressure Fp for balancing is higher than in the conventional head slider by Fn(Ln−L1)/(L1+L2).

This means that in the head slider 1 of the embodiment, the pad 6 is provided near the air-inlet-side end of the main body, thereby reducing the contact force Fc between the contact surface A of the pad 3 and the surface 16a of the magnetic disk 16, as compared to the conventional case, and also increasing the rigidity of the air layer formed between the head slider 1 and the surface 16a of the magnetic disk 16 to thereby maintain the week contact force.

The reduction of the contact force Fc suppresses the wear of the pad 3 and the damage of the magnetic disk 16 due to the friction therebetween. Moreover, the increase of the rigidity of the air layer enhances the stability of the head slider 1, which suppresses the vibration of the head slider 1 that occurs when an impact has been exerted thereon from the outside. As a result, a reduction in the level of a signal and uneven abrasion of the head slider 1 can be avoided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

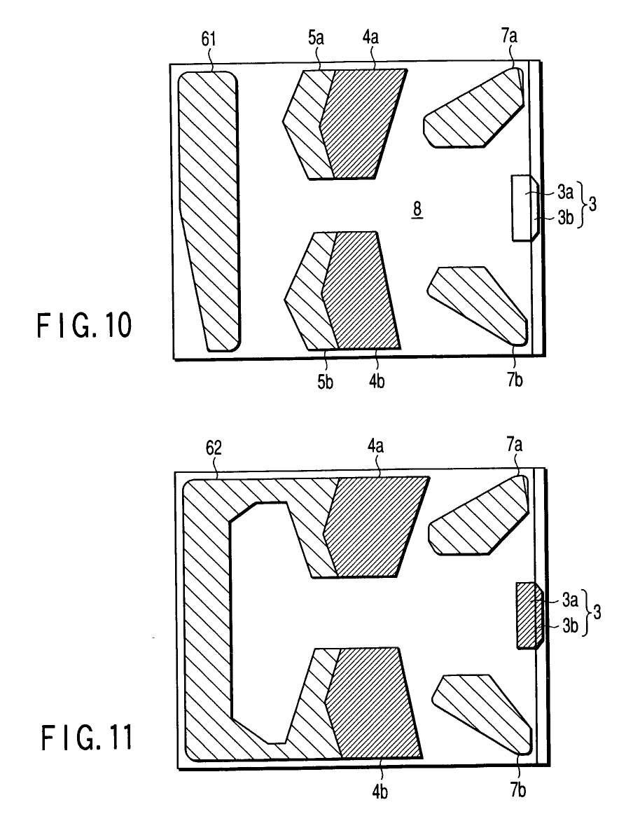

For example, the shape, size, height, etc. of the pad 6 for generating the negative pressure Fn are not limited to the above-described ones, but may be modified as shown in FIGS. 10-15.

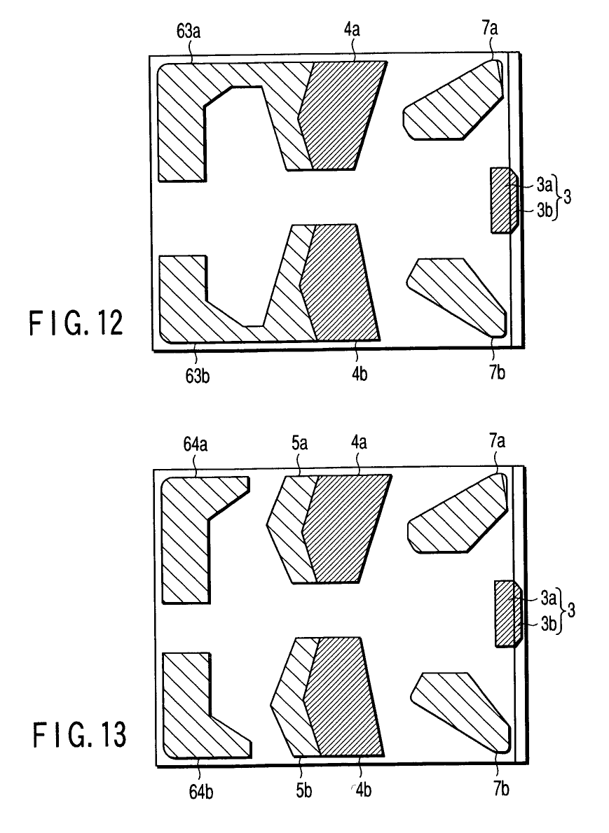

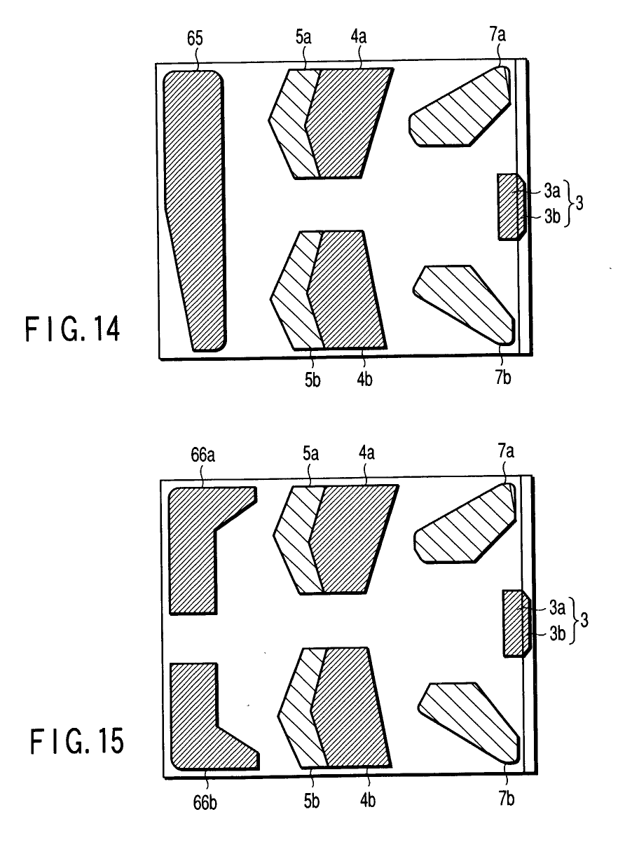

FIG. 10 shows a pad 61 in which only a part of its air-inlet-side end is inclined instead of forming it into a V-shape. FIG. 11 shows a pad 62 formed integral with the pads 5a and 5b that have surfaces B for guiding the airflow T to the positive pressure surface A. A greater negative pressure can be generated by forming the pad 62 such that it surrounds a negative-pressure generating portion located downstream of the pad 62. FIG. 12 shows pads 63a and 63b obtained by cutting out a portion of the pad 62 in FIG. 11 which surrounds the negative-pressure generating portion. The negative pressure can be controlled by cutting out a portion of the annular pad. FIG. 13 shows pads 64a and 64b obtained by separating the pads 5a and 5b from the pads 63a and 63b in FIG. 12, respectively. More accurate negative-pressure control can be realized by providing such separated portions. Further, FIG. 14 shows a pad 65 obtained by increasing the height of the pad 61 in FIG. 10 to have a surface A. FIG. 15 shows pads 66a and 66b obtained by increasing the height of the pads 64a and 64b in FIG. 13 to have a surface A. The height of the pad for generating a negative pressure is not limited to those specified in the embodiments. It is sufficient if the pad is higher than the surface C as shown in FIGS. 14 and 15.

Although the above-described embodiments employ the pad 6 near the air-inlet-side end of the head slider 1 for generating a negative pressure at a position downstream of the pad 6, another negative-pressure-generating means may be employed. The important thing is to adjust the negative-pressure-generating position and the negative pressure value, and how this is achieved is not important.

What is claimed is:

1. A head slider mounted with a head which records information on a rotating disk medium, and/or reproduces information therefrom, the head slider substantially radially moving over the rotating disk medium in a state in which a part of the head slider is in contact with a surface of the rotating disk medium, comprising:
a contact portion to be brought into contact with the surface of the disk medium, the contact portion being located downstream of a pressing position with respect to rotation of the disk medium, a pressing force being exerted upon the head slider at the pressing position to press the head slider against the surface of the disk medium;
a positive-pressure-generating portion located upstream of the pressing position with respect to the rotation of the disk medium, a positive pressure resulting, at the positive-pressure-generating portion, from airflow which occurs while the disk medium is rotating, thereby pressing the head slider away from the disk medium; and
a negative-pressure-generating portion located upstream of the positive-pressure-generating portion with respect to the rotation of the disk medium, a negative pressure resulting from the airflow at the negative-pressure-generating portion, thereby pressing the head slider toward the disk medium.

2. A head slider according to claim 1, wherein the negative-pressure-generating portion has a projection which partially interrupts the airflow, the negative pressure being generated downstream of the projection with respect to the airflow.

3. A head slider according to claim 2, wherein the projection extends in a direction intersecting the airflow.

4. A head slider according to claim 1, further comprising a damping portion provided between the contact portion and the positive-pressure-generating portion, the damping portion suppressing vibration of the head slider by changing a direction of the airflow, thereby stabilizing the head slider.

5. A disk device comprising:
a disk medium;
a spindle motor which supports and rotates the disk medium;
a head slider mounted with a head which records information on the disk medium and/or reproduces information therefrom while the disk medium is rotating;
a suspension arm having a free end provided with the head slider; and
a voice coil motor which swings the suspension arm to substantially radially move the head slider over the disk medium while the disk medium is rotating, in a state in which a part of the head slider is in contact with a surface of the rotating disk medium, thereby positioning the head above a desired track of the disk medium,
wherein the head slider includes:
a contact portion to be brought into contact with a portion of the surface of the disk medium, the contact portion being located downstream of a pressing position with respect to rotation of the disk medium, a pressing force being exerted upon the head slider at the pressing position to press the head slider against the surface of the disk medium;
a positive-pressure-generating portion located upstream of the pressing position with respect to the rotation of the disk medium, a positive pressure resulting, at the positive-pressure-generating portion, from airflow which occurs while the disk medium is rotating, thereby pressing the head slider away from the disk medium; and
a negative-pressure-generating portion located upstream of the positive-pressure-generating portion with respect to the rotation of the disk medium, a negative pressure resulting from the airflow at the negative-pressure-generating portion, thereby pressing the head slider toward the disk medium.

6. A disk device according to claim 5, wherein the negative-pressure-generating portion has a projection which partially interrupts the airflow, the negative pressure being generated downstream of the projection with respect to the airflow.

7. A disk device according to claim 6, wherein the projection extends in a direction intersecting the airflow.

8. A disk device according to claim 5, further comprising a damping portion provided between the contact portion and the positive-pressure-generating portion, the damping portion suppressing vibration of the head slider by changing a direction of the airflow, thereby stabilizing the head slider.
